(19) United States
(12) Patent Application Publication
(10) Pub. No.: US 2025/0005270 A1
(43) Pub. Date: Jan. 2, 2025

(54) SYSTEM AND METHOD FOR MANAGING DATA SHARE REQUESTS

(71) Applicant: Synchrony Bank, Stamford, CT (US)

(72) Inventors: Murray Pelta, Atlanta, GA (US); Rachel Marks, Kansas City, KS (US); Sven Miller, Salt Lake City, UT (US); Annmarie Nowak, Bartlett, IL (US); Joseph Jurchak, Valatie, NY (US); James McCarthy, Matthews, NC (US); Christine Schultz, Stamford, CT (US); Justin Heller, Stamford, CT (US)

(73) Assignee: Synchrony Bank, Stamford, CT (US)

(21) Appl. No.: 18/762,756

(22) Filed: Jul. 3, 2024

Related U.S. Application Data
(63) Continuation of application No. 17/548,049, filed on Dec. 10, 2021, now Pat. No. 12,061,865.
Application No. 17/548,049 is a continuation of application No. 15/666,800, filed on Aug. 2, 2017, now Pat. No. 11,232,256.

(51) Int. Cl. G06F 40/174; G06Q 10/0635

(52) U.S. Cl. CPC G06F 40/174; G06Q 10/0635

(57) ABSTRACT

A system and method for managing data share requests. An electronic form processing module receives a request to share data relating to an organization with an entity not affiliated with the organization. The request includes responses to questions presented in an electronic form. At least some of the questions presented in the electronic form are presented based on a response to a previously asked question in the electronic form. A score calculation module calculates a score based on the responses to the questions presented in the electronic form. A risk analysis module determines whether to approve, deny or escalate the request to share data based on the score.

### CROSS-REFERENCE TO RELATED APPLICATION

The present application is a continuation of U.S. patent application Ser. No. 17/548,049 filed Dec. 10, 2021, which is a continuation of U.S. patent application Ser. No. 15/666,800 filed Aug. 2, 2017, now U.S. Pat. No. 11,232,256, which are incorporated herein by reference in their entireties.

### FIELD OF THE INVENTION

The invention relates to managing and assessing requests to share an organization's data with third parties.

### BRIEF SUMMARY OF EXEMPLARY EMBODIMENTS OF THE INVENTION

Exemplary embodiments of the invention are directed to a system and method for managing data share requests. An electronic form processing module receives a request to share data relating to an organization with an entity not affiliated with the organization. The request includes responses to questions presented in an electronic form. At least some of the questions presented in the electronic form are presented based on a response to a previously asked question in the electronic form. A score calculation module calculates a score based on the responses to the questions presented in the electronic form. A risk analysis module determines whether to approve, deny or escalate the request to share data based on the score.

In some embodiments, the questions are related to a recipient of the request to share data; a purpose associated with the request to share data; content of the data that is the subject of the request to share data; a source of the data that is the subject of the request to share data; and/or a method of transmitting the data that is the subject of the request to share data.

### BRIEF DESCRIPTION OF THE DRAWINGS

The foregoing summary, as well as the following detailed description of embodiments of the invention, will be better understood when read in conjunction with the appended drawings of an exemplary embodiment. It should be understood, however, that the invention is not limited to the precise arrangements and instrumentalities shown.

In the drawings:

FIG. 1 is a flow diagram illustrating an exemplary process of the present invention;

FIG. 2 is a flow diagram illustrating an exemplary process of the present invention;

FIG. 3 is a flow diagram illustrating an exemplary process of the present invention;

FIGS. 4A-4L are exemplary questions within the associated process in accordance with an exemplary embodiment of the present invention; and

FIG. 5 is an exemplary system for carrying out embodiments of the present invention.

### DETAILED DESCRIPTION OF THE EXEMPLARY EMBODIMENTS

The systems and methods of the present invention employ new technology used to process requests to share data relating to an organization with an entity that is not affiliated with the organization. More particularly, if data is sought to be transmitted to or shared with external parties (e.g., those that are not part of an organization's legal structure), the inherent risk associated with the data share request must be understood and associated controls applied, prior to the data being shared, in accordance with the organization's requirements, standards and policies. Data that is deemed to have inherent risk above what the organization is willing to tolerate must be approved by way of an established process prior to it being shared.

Existing processes that are used to analyze data share requests are largely implemented in silos, with different departments within an organization analyzing the data share request from a different perspective (e.g., separate reviews for legal, IT security, regulatory affairs, and compliance). This process lacks in efficiency, transparency, and consistency of results.

The present invention presents a unified method of assessing risk associated with a data share request. More particularly, a data share request is reviewed with reference to several risk factor themes, in an exemplary embodiment, as follows:

Recipient: Some recipients are covered under policies (e.g., Credit Bureaus, regulators) or may have contractual agreements in place (e.g., client partners or vendor suppliers) that may influence the assessment of risk associated with the data share request. Other recipients may simply be unauthorized to receive certain kinds or any data.

Purpose: It may be considered whether the quality of the data sought to be shared meets the associated business requirements or the recipients' expectations. The intended purpose of the data share request may be in conflict with the policies of the organization. In some situations, business records are created by the organization, but managed by a third party and may not meet the organization's policies with regard to records and information management.

Content: Critical data elements associated with the data share request may not be of sufficient quality, nor properly defined, for their intended use/purpose. For example, data provided to credit bureaus and consumers may not be measured for accuracy and completeness before it is transmitted. In still other examples, regulatory documents may need to be approved by the organization's counsel before transmission to a third party.

Source: In some instances, critical data elements or business records may be sourced from unauthorized repositories or outside of a defined system of record.

Transmission Method: The transmission method may also be considered. For example, external data transmissions are not implemented in accordance with certain standards applicable to an organization. Information sent over the Internet may be intercepted or altered during transmission or in storage. Individually identifiable customer information and other sensitive information may not be transmitted securely and/or inappropriately used or disclosed.

The process for assessing data share requests should be considered in light of a variety of policies. For example, data that is subject to the policies of the organization or to regulations/laws requires a risk assessment, review and, where appropriate, risk acceptance before it is shared or transmitted to an external entity. By way of further example, data transmissions need to be fully inventoried, risk assessed against policies and legal requirements, tracked and reported upon. Existing, recurring transmissions are periodically re-evaluated based upon their level of risk. Further, critical data transmitted to a third party is associated with a business process that drives the requirements for what is transmitted (in/out bound). Still further, only data required to support the process is transmitted. Moreover, changes to existing approved data transmission arrangements are monitored, assessed, and subjected to re-approval to the extent that such changes are material or significant. By way of other considerations, controls and measurable risk management processes are implemented to limit data transmission to what is needed to service partner relationships and meet the business obligations of an organization and protect data transmissions. Finally, non-standard data transmissions must follow the defined escalation process and are subject to exception tracking. Approvals and exceptions should not be granted for data transmission requests that violate legal requirements.

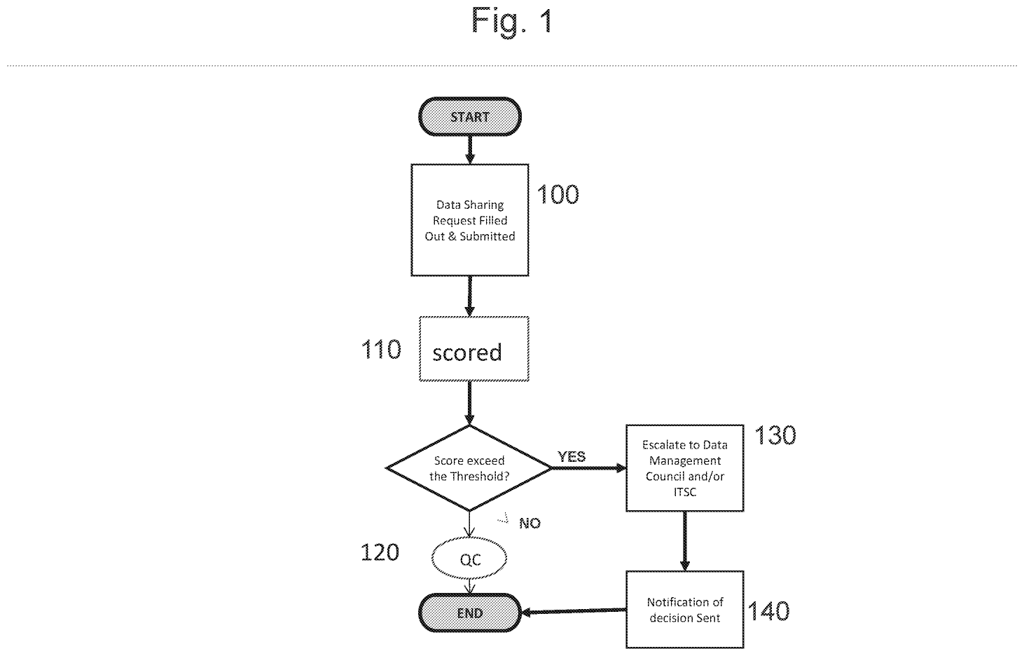

By way of overview of the inventive process, reference is made to FIG. 1. The individual presenting a data share request completes a form. The data entered onto the form is submitted to the computer system and assessed, in step 100. Based on the data entered into the form, in view of the assessment, the risk associated with the data share request is scored, in step 110. When risks associated with a data share request exceed a baseline threshold, the request will be escalated to upper level management of an organization for risk review, in step 130. Otherwise, the data share request undergoes a quality control review, in step 120. A decision on the data share request is sent to the applicable team, in step 140, and the team implements the decision, thereby ending the process.

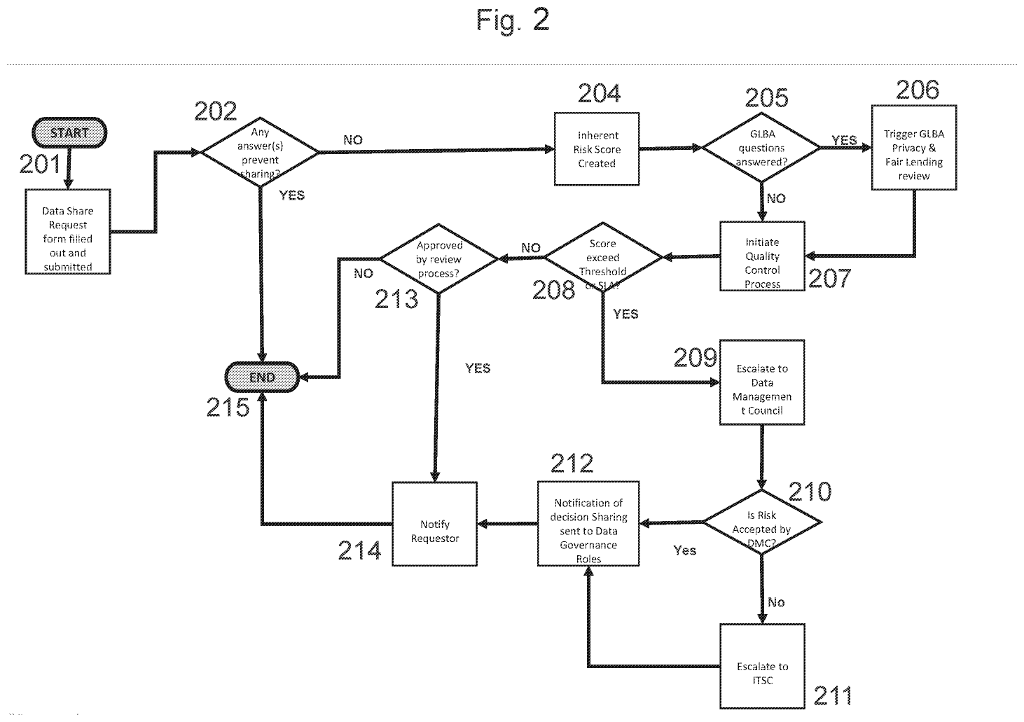

With reference to FIG. 2, a more detailed description of the process flow is described. In step 201, the data sharing request form is completed by the individual requesting the data share and the form is submitted to the system. In step 202, the answers to the questions in the form are evaluated to determine if data sharing should be prohibited. If so, in step 215, the process ends. If not, in step 204, the answers to the questions in the form are assessed and a risk score is produced, in step 204. In step 205, it is determined whether answers to certain of the questions that may be particularly relevant to an organization (e.g., Gramm-Leach-Bliley Act for financial services companies), in which case a more detailed review of these issues may be conducted in step 206 and it may be determined whether the nature of the data sharing request needs to be changed (e.g., whether the data share request form should be modified or amended and resubmitted, if warranted, pursuant to this this additional, in-depth review). If so, step 201 may be reinitiated. In step 207, additional quality control processes are initiated and the quality control process is undertaken. In step 207, based on the quality control review, it is determined whether the data share request form requires modification or amendment. If so, step 201 may be reinitiated. If not, in step 208 it is determined (by the computer system) whether the score exceeds a threshold score (e.g., more than 3.5). If not, In step 213, a quality control review process executes and determines if it is appropriate to share the data. If so, a notification is sent to the requestor in step 214 with the process ending at step 215. If not, the process may end at step 215 or result in the process restarting with step 201. If in step 208 the risk score exceeds 3.5, then step 209 is executed. In step 209, the request is escalated for further review (e.g., data management council of an organization). In step 210, it is determined whether the risk is acceptable. If not, in step 211 the request is further escalated for executive level review (e.g. a management sub-committee or committee of an organization,). In so, in step 212 a notification of the decision is sent to data governance personnel within the organization and, in step 214, the requestor is notified.

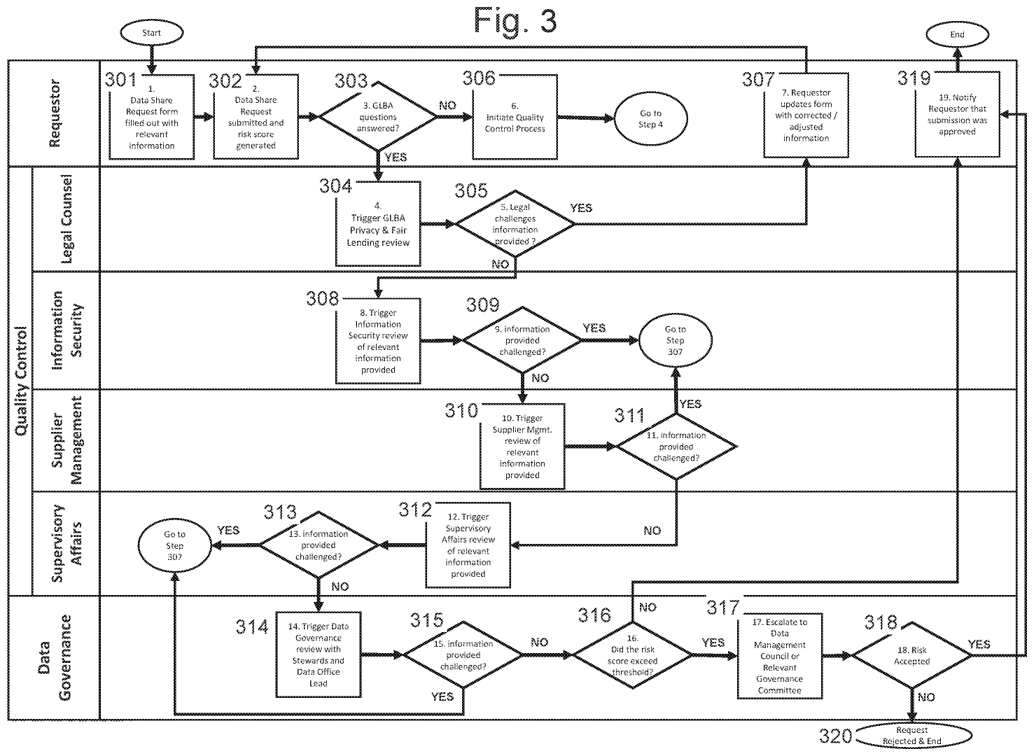

FIG. 3 describes an exemplary process for implementing quality control (i.e., step 207 of FIG. 2) in more detail. In step 301, the individual initiator of the data share request answers the questions posted in the request form and, in step 302, the answers to the questions are submitted to the system and scored. Steps 303, 304, and 305 are the equivalent of steps 205 and 206 of FIG. 2. As part of step 306, steps 308 and 309 are executed such that the questions and associated responses that are associated with Information Security risks are evaluated by Information Security professionals (e.g., is the data being shared considered personally identification information (PII), is the appropriate method (e.g. email, file feed, internet portal) for how the data will be shared selected, is the appropriate form of encryption or protection selected). In step 309, Information Security can challenge the responses provided should the combinations violate policy. In such instances where a challenge is raised, the request is sent back to the original requestor in step 307 for revision. Otherwise, upon successful review, the data share request will progress to the next quality control step. In steps 310 and 311, if data is being shared with an entity that has a relationship with the company (such as a vendor/supplier, client/partner, or partner vendor), a Supplier Management review is conduced. In step 310, it is considered whether the existing contractual relationship with that entity covers data sharing (e.g., has appropriate confidentiality provisions). Should the combination of data being shared misalign with the nature of the relationship with the company contractually, those answers can be challenged in step 311, resulting in the request being sent back to the requestor for revision in step 307. Once the request completes steps 308 through 311 successfully, the process moves to step 312. In step 312, questions related to sharing data with regulators are reviewed by a Supervisory Affairs group following the same review/challenge process described previously. Based on completion of this review without challenge, a final series of Data Governance reviews take place in Steps 314 to 318, in which questions associated with data quality, data usage and types of data being shared is conducted in steps 314 and 315. In step 316, the risk score associated with the request is updated based on all answers being validated and no longer challenged. In step 316 it is determined whether (based on the risk score exceeding the risk threshold establish by the company) the data sharing request requires an escalated approval (step 317) or if risk acceptance (step 318) is required. If the risk associated with sharing the data requested is not risk accepted, the request is rejected and requestor notified (in step 320). Otherwise, if the risk is accepted or if it the risk did not exceed the threshold, then the requestor is notified (in step 319) and the requestor can share the data consistent with information reviewed and approved.

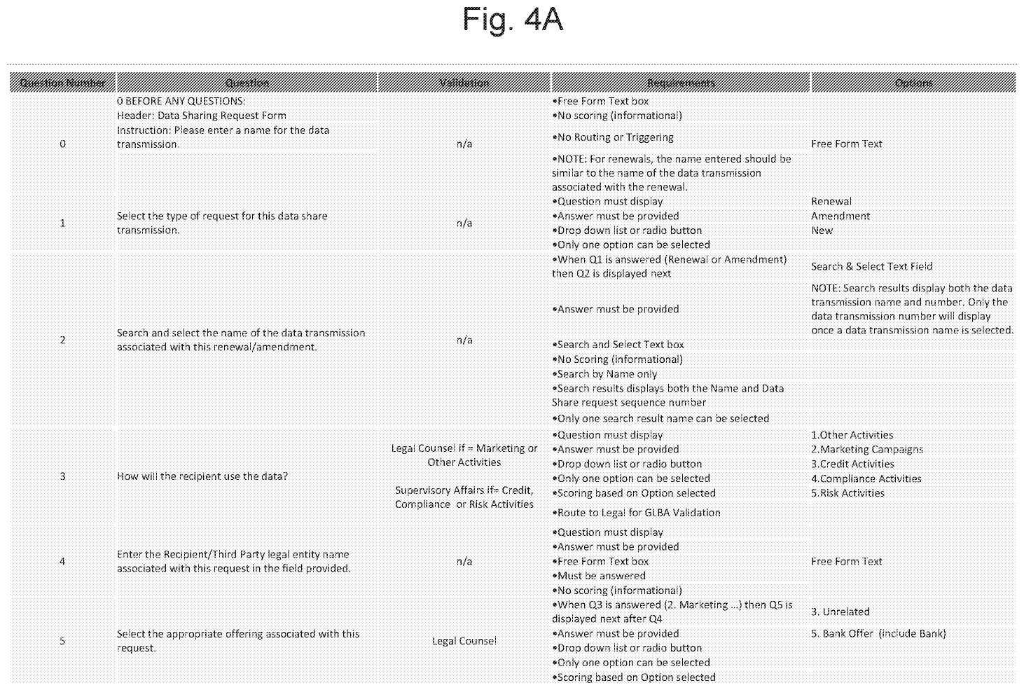

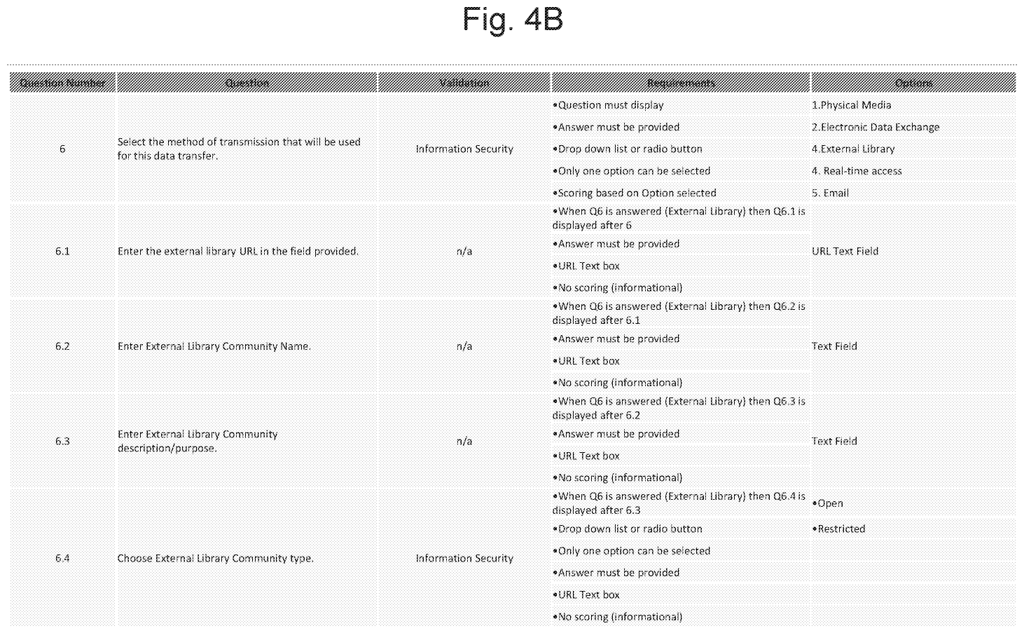

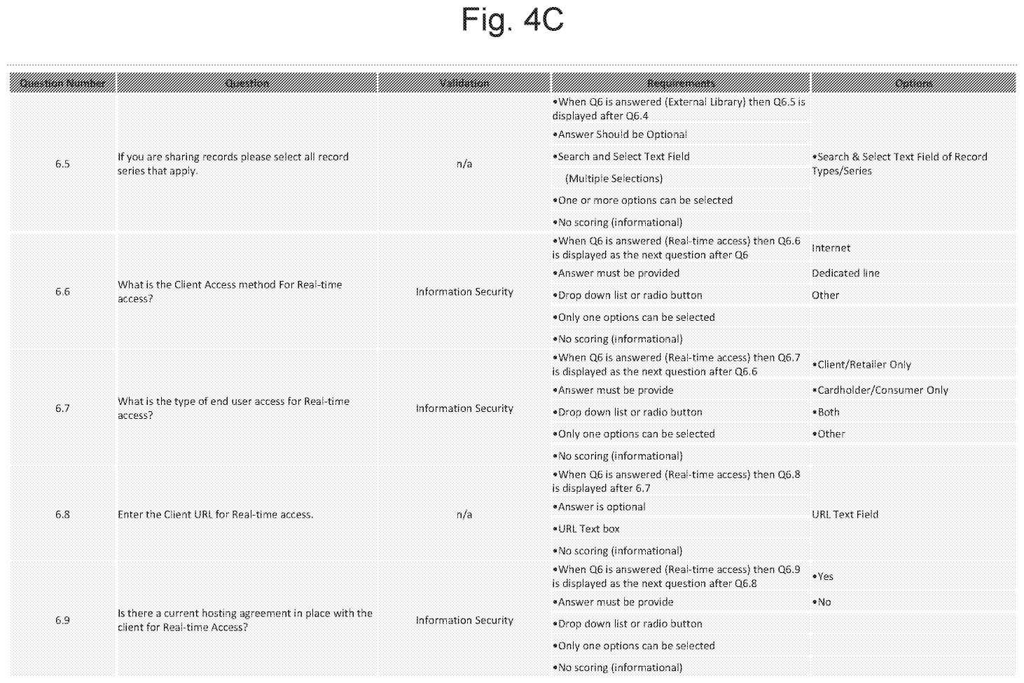

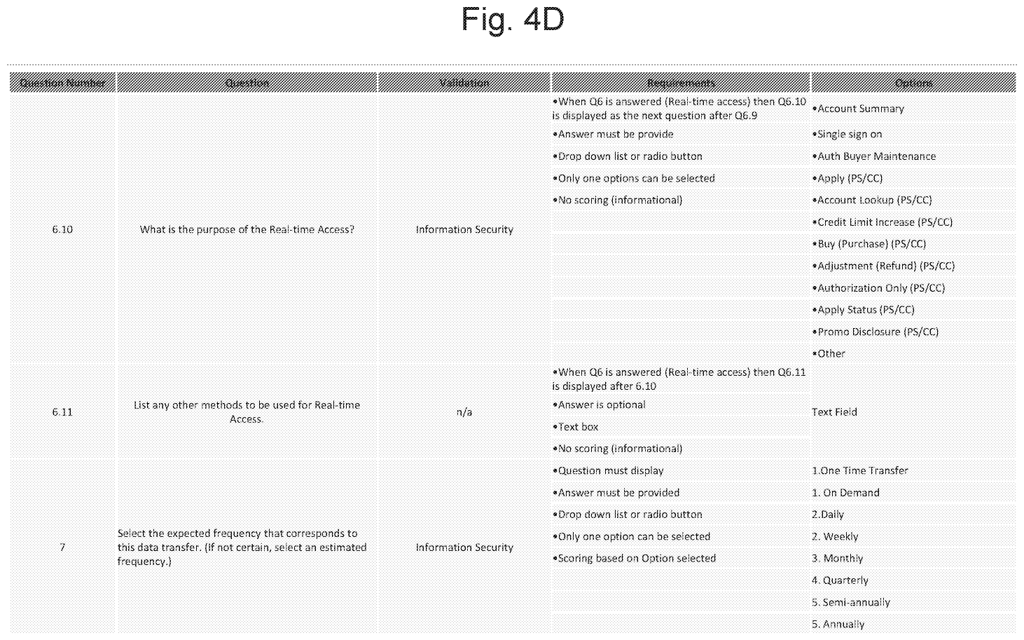

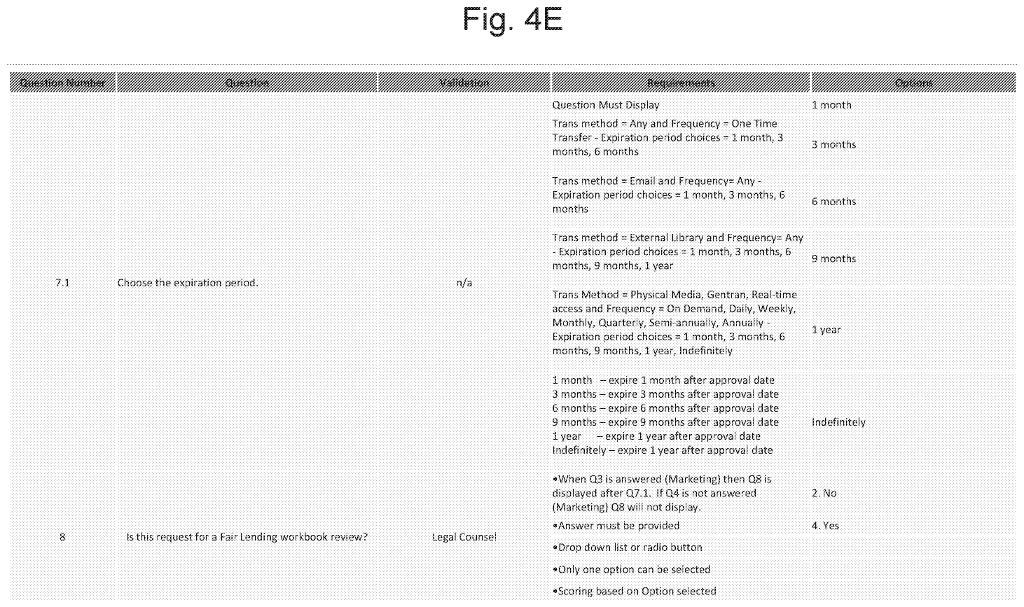

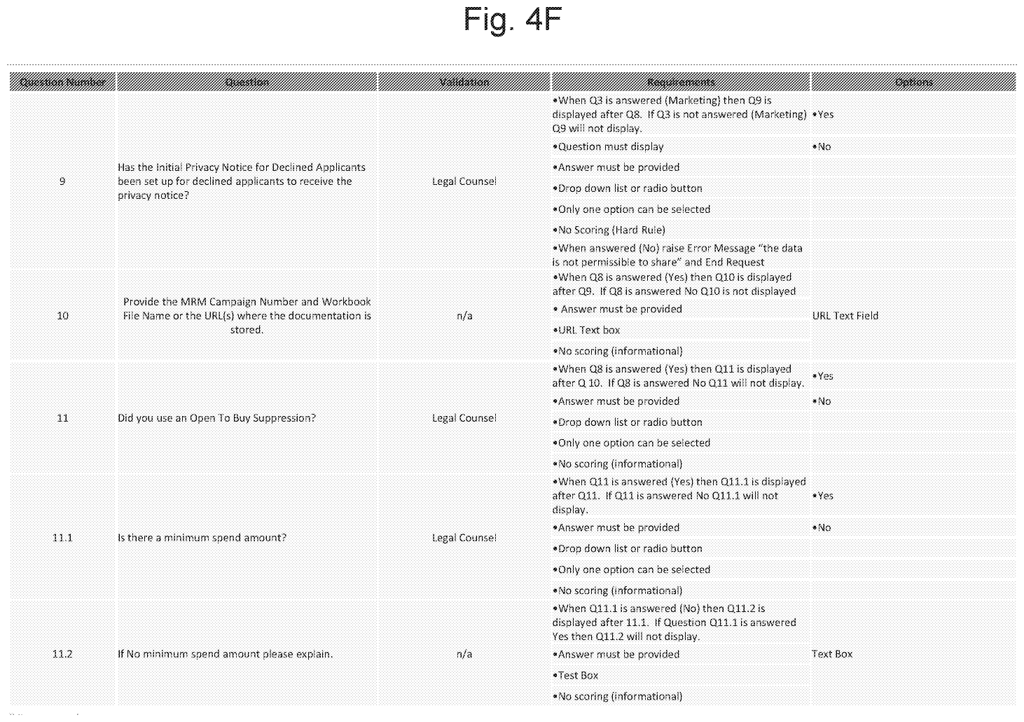

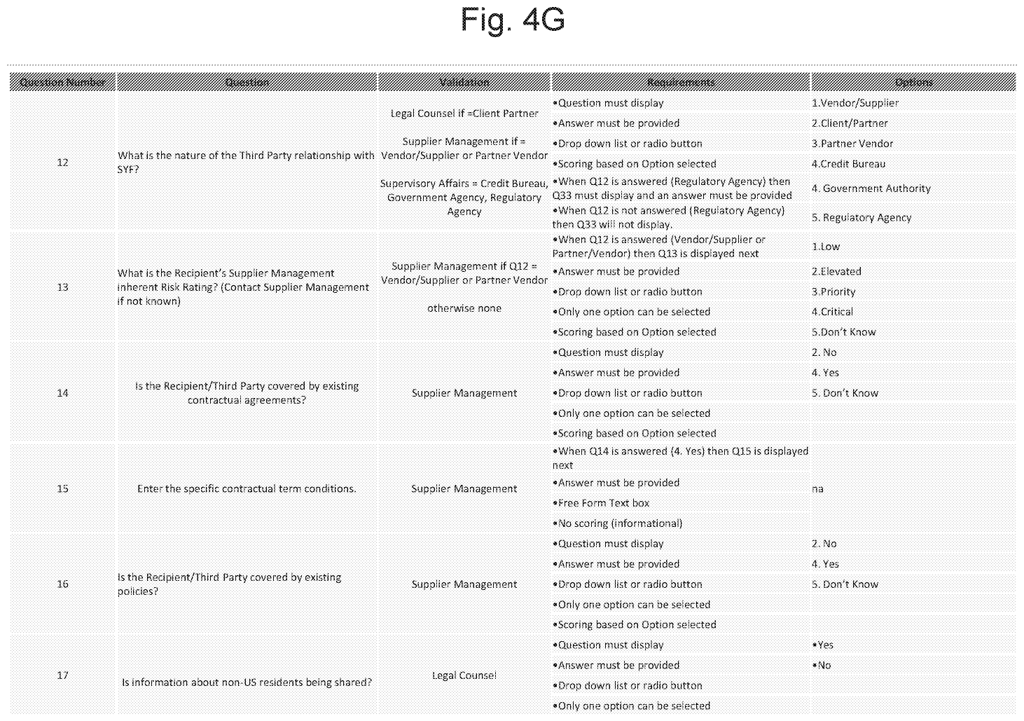

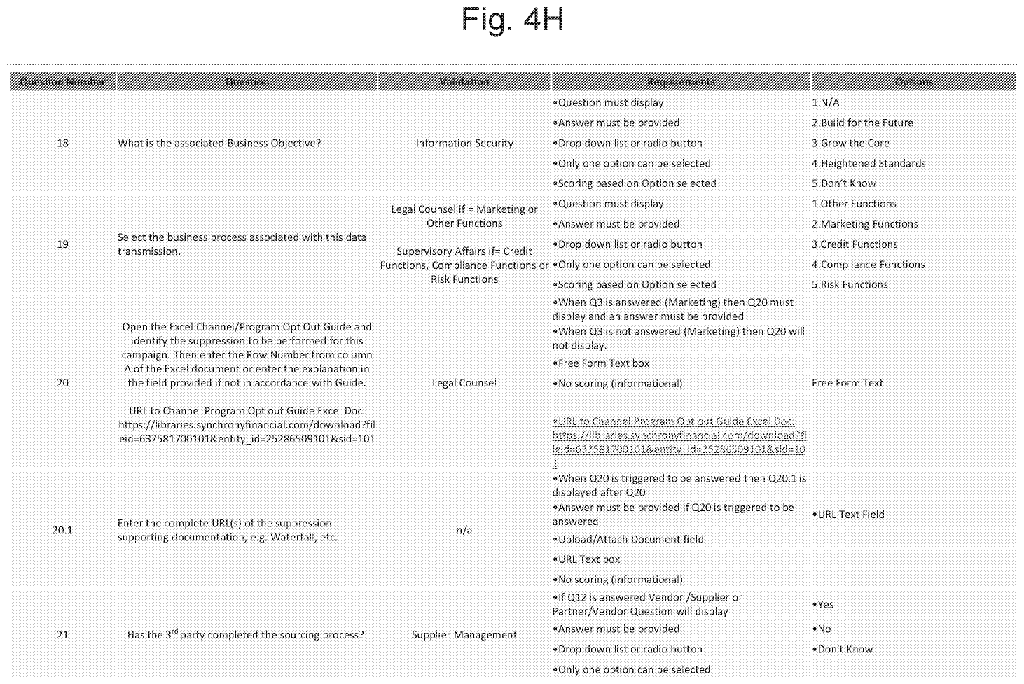

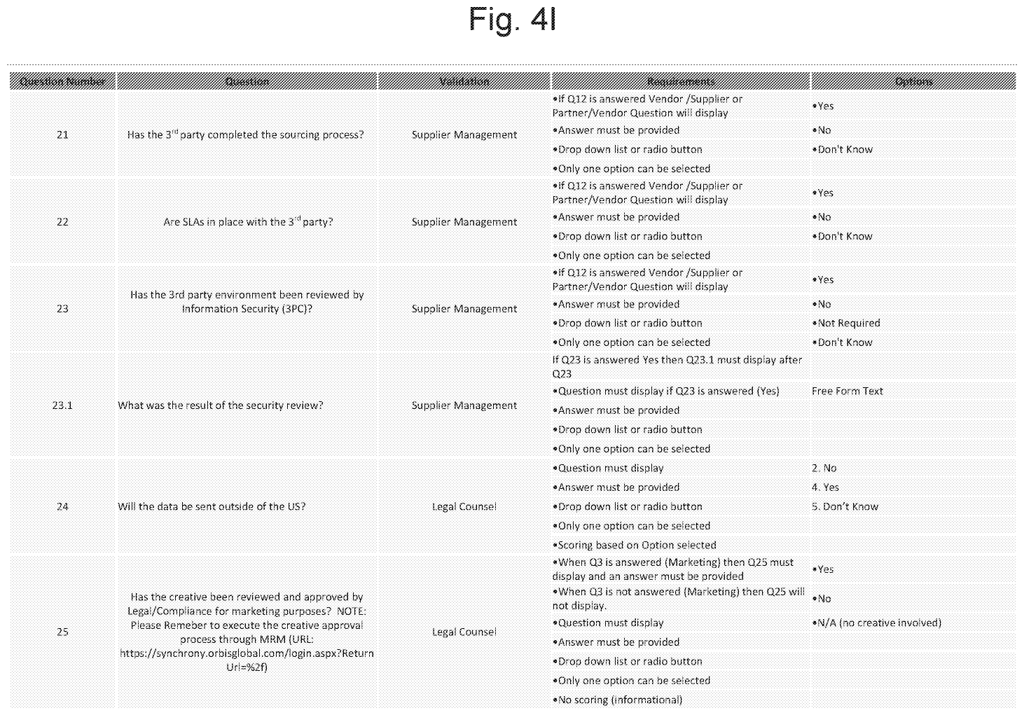

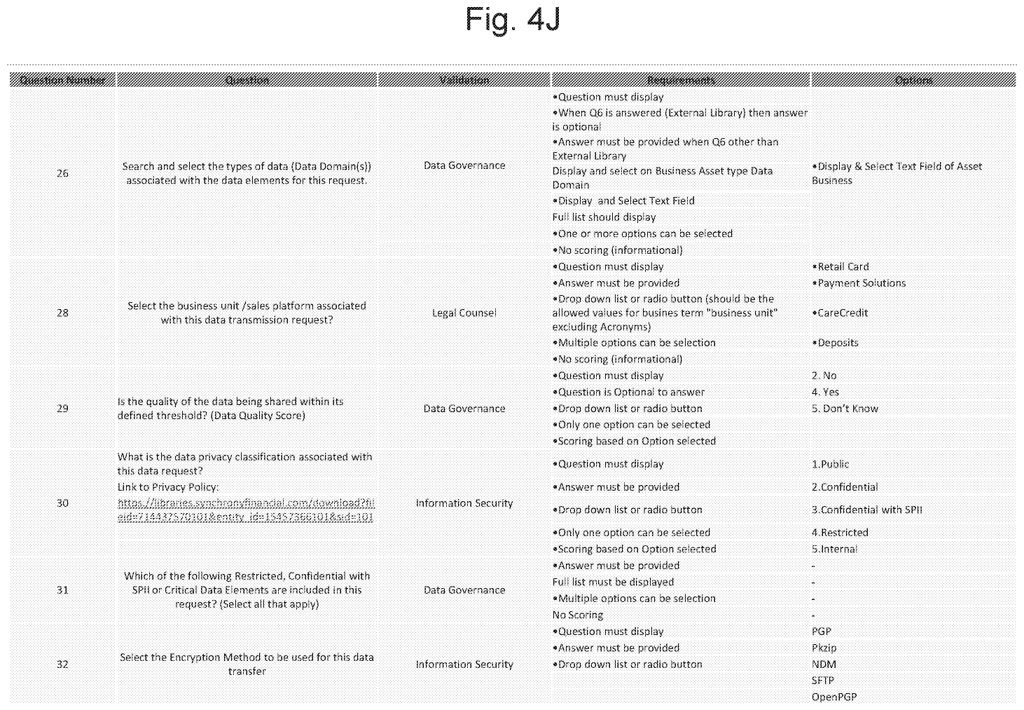

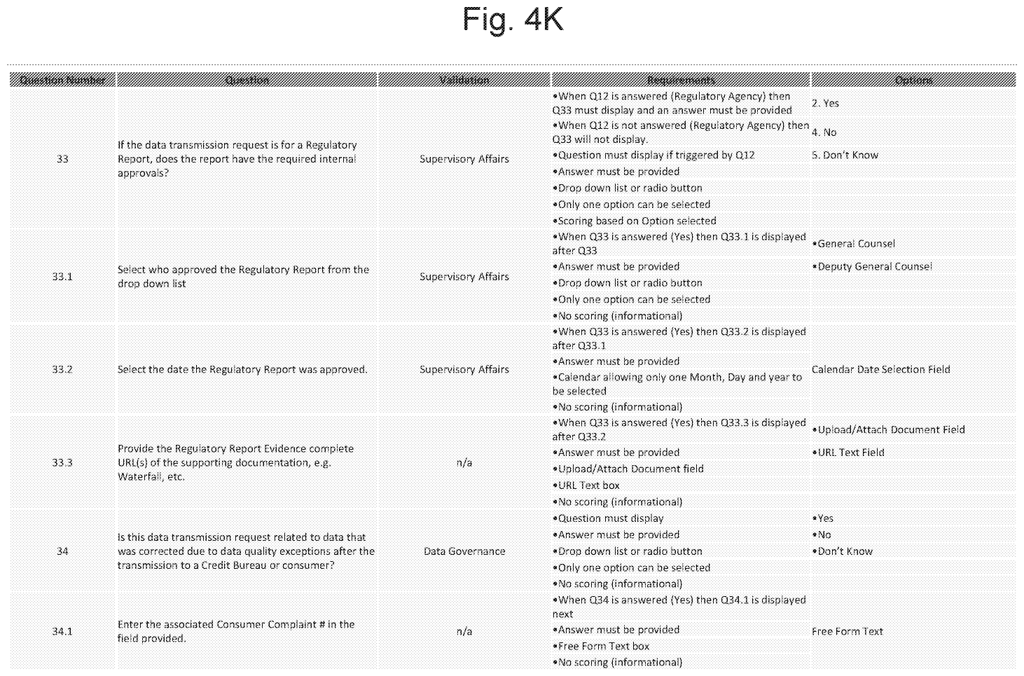

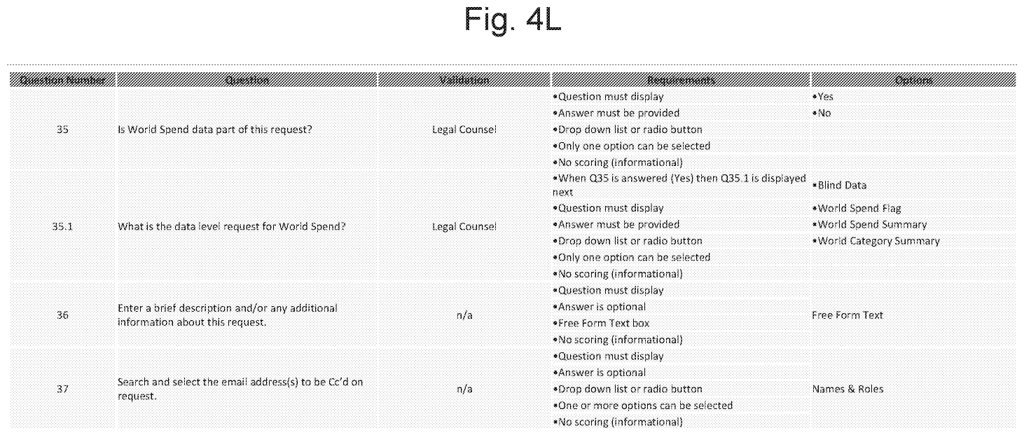

FIGS. 4A through 4L illustrate the electronic form, workflow-based methodology for submitting and reviewing a data share request. For example, FIG. 4A sets forth the questions that are presented to the requestor by way of an electronic form. FIG. 4A also illustrates the form logic associated with the questions presented and question flow based on the answers to the questions along with which organizational role is involved with the information review/challenge (as described in FIG. 3). For example, with reference to FIG. 4B, if question 6 is answered using the ‘External Library’ option, then questions 6.1, 6.2, 6.3, 6.4 and 6.5 are presented but, if question 6 is answered using the ‘Real-time access’ option, then questions 6.6, 6.7, 6.8, 6.9, 6.10 and 6.11 are presented, but if question 6 is answered any other option, then question 7 is presented (skipping question 6.1 through 6.11 inclusively). The answer options are also associated with a number, in the example shown. For example, there for 5 options for answers to question 6: 1—physical media; 2—electronic data exchange; 4—external library; 4—Real-time access and 5—email. The numbers associated with these options are used in the scoring, as described in more detail below. Some answers to questions are informational and not associated with scoring. Certain of the answer fields are free form text fields (e.g., question 1), and some may be through drop down menu (e.g., single selection, multiple selection). Some fields may allow for attaching documents for review or accept as an input a URL pointing to materials for review. FIGS. 4B through 4L show similar examples of answer-based presentation of the electronic form questions.

In one embodiment, a score is determined based on the average of the attributes that contain a numeric value (e.g., step 204 of FIG. 2). By way of a simplified example, if question 3 is answered with a numeric value of 4, question 6 is answered with a value of 3, and question 11 is answered with a value of 5, the score for these questions will be 4+3+5/3=4. The score is then compared to a threshold (e.g., step 208 of FIG. 2). In this example, a 5 point scale may be used and the threshold may be 2. If the score is less than 2, then (subject to quality control review) the data share request may be granted. If the score is 2 or greater, additional review and assessment may be required. Other point scales, scoring techniques or thresholds may be used within the scope of the present invention. Also, other methods of determining whether the risk associated with a data share request is acceptable are within the scope of the present invention. For example, a score may not be used, but another quantitative, objective evaluator of risk may be used, within the scope of the present invention.

A computer is required to carry out the methods of the present invention because the assessment of the request using the workflows requires a significant number of permutations. The number of questions, options and combinations to both create a risk score and to ensure appropriate real-time workflow routing of review results in a deterministic combinatorial problem. Deterministic problems of this size (e.g. over a million combinations—60 questions to the 3rd (average number of sub-questions spawned multiplied by 5 (average number of options with scores)) require a computer system to calculate in real-time fashion.

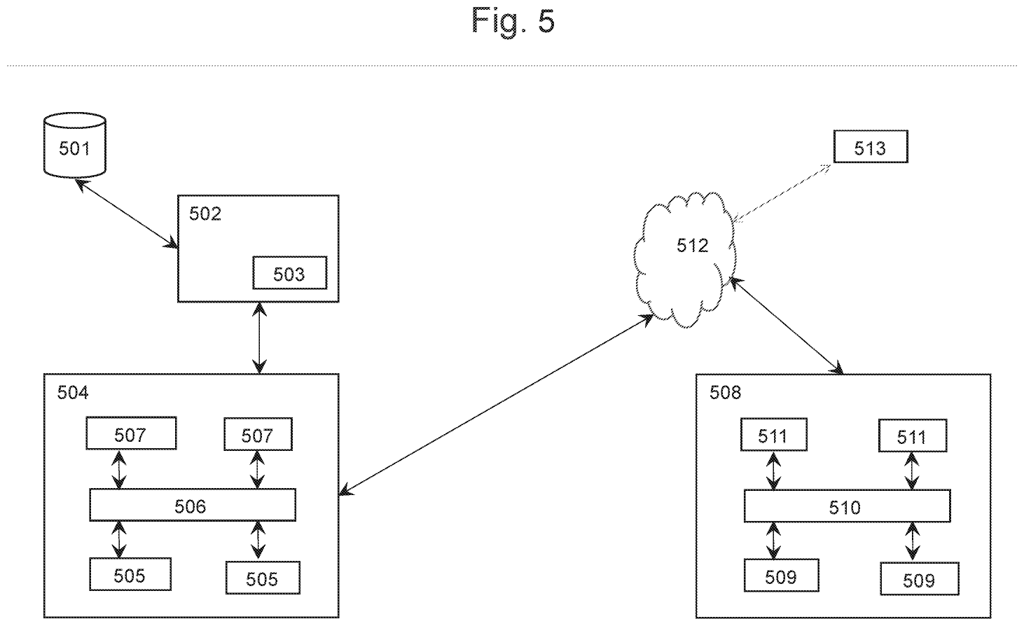

In some embodiments, the methods are carried out by a system that employs a client/server architecture such as, for example, the exemplary embodiments described as follows with reference to FIG. 5. The data that may be used as an input to the system and the outputs from the system(s) may be stored in one or more databases 501. Database server(s) 502 may include a database services management application 503 that manages storage and retrieval of data from the database(s) 401. The databases 501 may be relational databases; however, other data organizational structures may be used without departing from the scope of the present invention. Thus, for example, the electronic forms, as well as the data input into the forms, the calculated scores, and data relating to the decisions as to the data share request, may be stored in databases 501.

One or more application server(s) 504 are in communication with the database server 502. The application server 504 communicates requests for data to the database server 502. The database server 502 retrieves the requested data. The application server 504 may also send data to the database server 502 for storage in the database(s) 501. The application server 504 comprises one or more processors 505, non-transitory computer readable storage media 507 that store programs (computer readable instructions) for execution by the processor(s), and an interface 506 between the processor(s) 505 and computer readable storage media 507. The application server 504 may store the computer programs and code used to implement the methods of the present invention. Thus, for example, the application server 504 would store the software necessary to implement the electronic form, work flows, calculate a score from the responses, and make a decision as to whether the risk associated with the data share request is acceptable.

To the extent data and information is communicated over a network (e.g., the Internet or an Intranet), one or more network servers 508 may be employed. The network server 508 also comprises one or more processors 509, computer readable storage media 511 that store programs (computer readable instructions) for execution by the processor(s), and an interface 510 between the processor(s) 509 and computer readable storage media 511. The network server 508 is employed to deliver content that can be accessed through the communications network 512, e.g., by an end user employing computing device 513. When data is requested through an application, such as an Internet browser, the network server 508 receives and processes the request. The network server 508 sends the data or application requested along with user interface instructions for displaying an interface on device 513.

The computers referenced herein are specially programmed to perform the functionality described herein.

The non-transitory computer readable storage media (e.g., 507 or 511) that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

1. (canceled)

2. A computer-implemented method comprising:
assessing a plurality of risk factors associated with a data share request, wherein the data share request represents a request from a requestor device to share a set of data with a third party, wherein the data share request is associated with a workflow, wherein the data is associated with risk factors and analysis silos, wherein the plurality of risk factors correspond to a plurality of risk types, and wherein the analysis silos are associated with organizational roles corresponding to the plurality of risk factors;
determining a score associated with one or more answers from a unified electronic form, wherein determining the score is based on the plurality of risk factors and the workflow, wherein the score is associated with a risk type, wherein the risk type corresponds to a validation endpoint of the workflow, and wherein the one or more answers are associated with the requestor device and are provided in response to one or more questions;
determining, in association with the workflow, that the score exceeds a threshold determined in association with the workflow; and
escalating the data share request based on a routing associated with the workflow.

3. The computer-implemented method of claim 2, wherein assessing the plurality of risk factors comprises presenting the one or more questions within the unified electronic form and wherein assessing the plurality of risk factors is based on the one or more answers.

4. The computer-implemented method of claim 3, further comprising:
determining that the validation endpoint has raised a challenge the one or more answers; and
sending the data share request back to the requestor device.

5. The computer-implemented method of claim 2, further comprising notifying the requestor device of the determination that the score exceeds the threshold and routing the data share request in real-time to the validation endpoint.

6. The computer-implemented method of claim 2, wherein assessing the plurality of risk factors associated with the data share request comprises:
determining that the data share request requires one or more modifications;
allowing the requestor device to modify the data share request;
receiving a modified data share request; and
assessing the modified data share request.

7. The computer-implemented method of claim 2, wherein the data share request is among a plurality of recurring data share requests, the method further comprising:
re-evaluating the data share request periodically.

8. The computer-implemented method of claim 2, wherein the plurality of risk factors associated with the data share request includes at least one of: a category of the set of data, a method for how the set of data is to be shared, a form of encryption, a form of protection, a type of relationship with the third party, a contractual relationship with the third party, data quality, data usage, type of data access, and data requirements.

9. A system comprising:
a communication interface that receives a data share request associated with a requestor device to share a set of electronic data with a third party; and
a processor that executes instructions stored in memory, wherein when executed, the instructions cause the processor to perform operations comprising:
assessing a plurality of risk factors associated with the data share request, wherein the data share request represents a request from a requestor device to share a set of data with the third party, wherein the data share request is associated with a workflow, wherein the data is associated with risk factors and analysis silos, wherein the plurality of risk factors correspond to a plurality of risk types, and wherein the analysis silos are associated with organizational roles corresponding to the plurality of risk factors;
determining a score associated with one or more answers from a unified electronic form, wherein determining the score is based on the plurality of risk factors and the workflow, wherein the score is associated with a risk type, wherein the risk type corresponds to a validation endpoint of the workflow, and wherein the one or more answers are associated with the requestor device and are provided in response to one or more questions;
determining, in association with the workflow, that the score exceeds a threshold determined in association with the workflow; and
escalating the data share request based on a routing associated with the workflow.

10. The system of claim 9, wherein assessing the plurality of risk factors comprises presenting the one or more questions within the unified electronic form and wherein assessing the plurality of risk factors is based on the one or more answers.

11. The system of claim 10, wherein when executed, the instructions cause the processor to perform operations comprising:
determining that the validation endpoint has raised a challenge the one or more answers; and
sending the data share request back to the requestor device.

12. The system of claim 10, wherein when executed, the instructions cause the processor to perform operations comprising notifying the requestor device of the determination that the score exceeds the threshold and routing the data share request in real-time to the validation endpoint.

13. The system of claim 10, wherein assessing the plurality of risk factors associated with the data share request comprises:
determining that the data share request requires one or more modifications;
allowing the requestor device to modify the data share request;
receiving a modified data share request; and
assessing the modified data share request.

14. The system of claim 10, wherein the data share request is among a plurality of recurring data share requests, and wherein the instructions cause the processor to perform operations comprising:
re-evaluating the data share request periodically.

15. The system of claim 10, wherein the plurality of risk factors associated with the data share request includes at least one of: a category of the set of data, a method for how the set of data is to be shared, a form of encryption, a form of protection, a type of relationship with the third party, a contractual relationship with the third party, data quality, data usage, type of data access, and data requirements.

16. A non-transitory computer-readable storage medium comprising instructions, that when executed, cause a processor to perform operations comprising:
assessing a plurality of risk factors associated with a data share request, wherein the data share request represents a request from a requestor device to share a set of data with a third party, wherein the data share request is associated with a workflow, wherein the data is associated with risk factors and analysis silos, wherein the plurality of risk factors correspond to a plurality of risk types, and wherein the analysis silos are associated with organizational roles corresponding to the plurality of risk factors;
determining a score associated with one or more answers from a unified electronic form, wherein determining the score is based on the plurality of risk factors and the workflow, wherein the score is associated with a risk type, wherein the risk type corresponds to a validation endpoint of the workflow, and wherein the one or more answers are associated with the requestor device and are provided in response to one or more questions;
determining, in association with the workflow, that the score exceeds a threshold determined in association with the workflow; and
escalating the data share request based on a routing associated with the workflow.

17. The non-transitory computer-readable storage medium of claim 16, wherein assessing the plurality of risk factors comprises presenting the one or more questions within the unified electronic form and wherein assessing the plurality of risk factors is based on the one or more answers.

18. The non-transitory computer-readable storage medium of claim 17, wherein executing the instructions causes the processor to perform operations comprising:
determining that the validation endpoint has raised a challenge the one or more answers; and
sending the data share request back to the requestor device.

19. The non-transitory computer-readable storage medium of claim 16, further comprising notifying the requestor device of the determination that the score exceeds the threshold and routing the data share request in real-time to the validation endpoint.

20. The non-transitory computer-readable storage medium of claim 16, wherein assessing the plurality of risk factors associated with the data share request comprises:
determining that the data share request requires one or more modifications;
allowing the requestor device to modify the data share request;
receiving a modified data share request; and
assessing the modified data share request.

21. The non-transitory computer-readable storage medium of claim 16, wherein the plurality of risk factors associated with the data share request includes at least one of: a category of the set of data, a method for how the set of data is to be shared, a form of encryption, a form of protection, a type of relationship with the third party, a contractual relationship with the third party, data quality, data usage, type of data access, and data requirements.
